(19) United States
(12) Patent Application Publication
(10) Pub. No.: US 2022/0024106 A1
(43) Pub. Date: Jan. 27, 2022

(54) BLOW MOLDED PLASTIC CONTAINER AND GAS STORAGE TANK COMPRISING THE BLOW MOLDED PLASTIC CONTAINER AS A LINER

(71) Applicant: DSM IP ASSETS B.V., HEERLEN (NL)

(72) Inventors: Jan STOLK, ECHT (NL); Vinayak KHATAVKAR, ECHT (NL)

(21) Appl. No.: 17/413,151

(22) PCT Filed: Dec. 10, 2019
(86) PCT No.: PCT/EP2019/084467

§ 371 Date: Jun. 11, 2021

(30) Foreign Application Priority Data
Dec. 14, 2018 (EP) 18212587.2
Mar. 18, 2019 (EP) 19163559.8

(51) Int. Cl. B29C 49/04; B60K 15/03; B29C 49/00; C08L 77/06; C08L 77/02; C08K 3/34; B29C 49/20; C08K 7/06; C08K 7/14

(52) U.S. Cl. CPC B29C 49/04; B60K 15/03; B29C 49/0005; C08L 77/06; B29L 2031/30; C08K 3/34; B29C 49/20; C08K 7/06; C08K 7/14; C08L 77/02

(57) ABSTRACT

The present invention relates to a blow molded plastic container and to a polymer composition from which the blow molded plastic container is made. The blow molded plastic container comprises a pinched seamline and is made by an extrusion blow molding process comprising a pinch step. The present invention also relates to a gas storage tank, comprising the blow molded plastic container as a liner. The polymer composition comprises (a) a polyamide consisting of a copolyamide consisting of repeat units derived from lactam, diamine and dicarboxylic acid, and optionally chain stoppers or branching units or a combination thereof, or of a blend of at least two polyamides, comprising at least one polyamide comprising repeat units derived from lactam, and at least one polyamide comprising repeat units derived from diamine and dicarboxylic acid, and comprising 75-97.5 mole % caprolactam and 1-12 mole % monomer having an aromatic ring, (b) a heat stabilizer and (c) impact modifier.

The present invention relates to a blow molded plastic container for a liner in a liquid fuel tank or a gas fuel tank, more particular for a gas storage tank, and to a polymer composition from which the plastic fuel container is made. The plastic container is made by an extrusion blow molding process comprising a molding step comprising a pinch step, due to which the plastic container comprises a pinched seamline or pinched seamlines. The present invention also relates to a fuel tank, more particular a gas storage tank, comprising the blow molded plastic container as a liner.

A liner for a gas storage tank containing a polymer composition comprising a polyamide and an impact modifier are known, for example, from U.S. Pat. Nos. 9,470,366 and 8,053,523. The composition of U.S. Pat. No. 9,470,366 further comprises a nucleating agent in an amount of at least 0.001 weight percent with respect to the total amount of the polymer composition. The hydrogen tank liner of U.S. Pat. No. 8,053,523 is made by blow molding or injection molding, in particular by blow molding. In the composition of U.S. Pat. No. 8,053,523, the polyamide consists of polyamide-6 and a copolyamide, more particular being PA6/66. The hydrogen tank liner of U.S. Pat. No. 8,053,523 is made by extrusion-molding, blow-molding, compression-molding or injection molding, in particular by forming two or more segments by injection molding and then welding the segments together by laser welding.

These patents do not describe an extrusion blow molding process, wherein tanks with a pinch line are made.

In an extrusion blow molding process, the products are formed in two steps: first, a hot parison is extruded in vertical direction on an extruder with the use of an extrusion die. Then the parison is expanded inside a mold cavity while blowing an expansion gas into the parison and closing the mold. The part of the mold which enables to cut off the excessive material from the manufactured product is called pinch-off zone. Those sections of a parison which are not taken within the cavity of a mold, and which are removed after blowing, are called pinch off. The pinch-off is later discarded or reused. Extrusion blow molded parts can fail at the parison pinch-off seam of the mold parting line. The pinch line at the bottom of the parison, i.e. at the lower pinch-off is generally more critical.

Meeting crash requirements is a critical part of the fuel tank safety performance evaluation. Steel tanks used to be the standard but are replaced increasingly by plastic tanks. Weight and safety play an important role. Seams in a steel tank, typically made by welding, are weak points of failure under crash impact and stresses. Steel tanks absorb energy by deforming when impacted in a crash, thereby increasing pressure as tank volume decreases, making failure likely at welded or clamped areas.

The use of plastic for fuel tanks offers various advantages over metal tanks. Quite importantly in a fire control situation, unlike metal fuel tanks, plastic tanks are not a source of sparks and prevent igniting fuel. Plastic fuel containers allow for significant weight reduction, leading to better fuel economy and lower CO2 emissions, are corrosion resistant and non-conductive, allow for more flexibility in design, result in less noise attenuation and with advanced composite structures and functional component integration low permeability can be achieved.

Extrusion blow molding involves steps of forming a parison and blow molding of the parison and pinching-off the end-parts from the parison. To form a strong top and bottom, the parison should be closed with good adhesion of the pinched seamline, also referred to as pinch line, which is formed by the pinch step.

A problem often encountered with plastic fuel containers made by extrusion blow molding and comprising a pinched seamline, is that the container is less crash resistant than a seamless container, as it fails more easily, and when it fails it fails easily at the pinched seamline. Common forms of part failure at the pinched seamline are cracking from impact, fatigue failure from flexing, or chemical stress cracking. Such failures are often related to material processing conditions, parison geometry, molding conditions, mold design, or a combination of these factors.

Solutions for these problems are typically sought in appropriate changes in processing and pinch-off design modifications. Both processing conditions and mold pinch-off geometry will influence the shape of the material inside the part and the integrity of the pinch-line bond. Developing the optimal material shape inside the part at the pinch-off is a key to building a seam-line with optimized part performance and integrity. That excess material is likely to shrink and warp because it is not cooled at the same rate as the surrounding part wall. Slower cooling may also increase the residual stress and degree of crystallinity in some materials, increasing the tendency for chemical stress cracking.

The current quest for and transition to other sources of energy in the automotive industry put further pressure on the requirements of systems used therein. The use of hydrogen gas is one example thereof, which is now intensively explored for new generations of automotive vehicles. With the use of hydrogen gas as a source of energy, the safety requirements become more severe, resulting in need for plastic fuel containers with even better performance.

Plastic fuel containers made by extrusion blow molding and intended for use as liner in a hydrogen gas tank construction are known, and are typically made of non-reinforced polyamide compositions, though some reinforcing components may be present.

Most gas storage tanks comprise a thin, non-structural liner wrapped with a structural fiber composite, designed to hold a fluid or gas under pressure. The liner intends to provide a barrier between the fluid or gas and the composite, preventing amongst others leaks and chemical degradation of the structural fiber composite. In general, a protective shell made of structural fiber composite is applied for protective shielding against impact damage. The most commonly used composites are fiber reinforced thermosets. Such compositions generally comprise a thermoset resin, and sometimes a thermoplastic aliphatic polyamide, and may further comprise, for example, reinforcing agents, impact modifier and nucleating agent. Herein the polyamide provides the barrier properties, whereas the other components are typically used to provide the container with the proper balance in mechanical properties, such as strength and impact resistance. However, it has been observed that for hydrogen gas tanks the properties of the pinched seamline need to be further improved. In particular for larger tanks, involving larger amounts of materials and longer processing times, the production of blow molded plastic containers with a pinch line with good properties appeared to become even more critical.

The aim of the present invention has been to provide a plastic container obtainable by a blow molding process comprising a pinch step, wherein the blow molded plastic container comprises a pinched seamline showing improved mechanical and integrity performance under impact conditions, with retention of good barrier properties, good mechanical properties and integrity performance of the blow molded plastic container as a whole.

This aim has been achieved with the blow molded plastic container according to the present invention, and with the polymer composition according to the present invention, of which the blow molded plastic container is made.

The blow molded plastic container according to the invention is made of a polymer composition comprising a polyamide (a), a heat stabilizer (b) and an impact modifier (c); with either aromatic groups in the polyamide (a) or presence of nigrosine (d), or a combination thereof. The composition optionally comprises or a nucleating agent (e), for enhancing the barrier properties of the polyamide in the plastic container, and other components.

One embodiment of the present invention relates to a polymer composition. Another embodiment of the invention relates to a blow molded plastic container, made of the polymer composition.

The polymer composition comprises:
a. polyamide (A) consisting of
   a copolyamide (A1) consisting of repeat units derived from lactam, diamine and dicarboxylic acid, and optionally chain stoppers or branching units or a combination thereof, or
   a blend (A2) of at least two polyamides, comprising at least one polyamide comprising repeat units derived from lactam, and at least one polyamide comprising repeat units derived from diamine and dicarboxylic acid, wherein the polyamide (A) comprises 75-97.5 mole % of repeat units derived from caprolactam and 1-12 mole % of repeat units derived from monomer having an aromatic ring, relative to the total molar amount of lactam, diamine and dicarboxylic acid;
b. a heat stabilizer; and
c. an impact modifier.

The blow molded plastic container according to the invention comprises a pinched seamline. The blow molded plastic container is made by an extrusion blow molding process comprising steps of (i) forming a parison and (ii) molding and blowing the parison and pinching-off the end-parts from the parison, thereby forming the pinched seamline. Herein the blow molded plastic container is either made of the polymer composition mentioned above, or is made of a polymer composition comprising:
a. a polyamide (A) consisting of
   polyamide 6 (A3); or
   a copolyamide (A4) comprising repeat units derived from lactam, or
   a blend (A5) of at least two polyamides, comprising at least one polyamide comprising repeat units derived from lactam, and at least one polyamide comprising repeat units derived from diamine and dicarboxylic acid, wherein the polyamide comprises at least 75 mole % of repeat units derived from caprolactam, relative to the total molar amount of lactam, diamine and dicarboxylic acid;
b. a heat stabilizer;
c. an impact modifier; and
d. 0.1-3 wt. % nigrosine, relative to the total weight of the polymer composition.

The effect of the blow molded plastic container according to the invention, made of a composition comprising PA-6 or PA-6 based aliphatic polyamide components and either a semi-aromatic polyamide or semi-aromatic polyamide components, or nigrosine, in combination with a heat stabilizer, is that the performance of the pinched seamline under impact conditions is improved, while the blow molded plastic container as a whole shows a good balance in barrier properties, mechanical properties and integrity retention under impact conditions. An impact modifier needs to present to provide low temperature impact resistance to the plastic container. However, this is not sufficient for the performance of the pinch line. This can be improved in absence of an impact modifier, provided the polyamide comprises the aromatic rings or nigrosine is present, and the composition comprises the heat stabilizer. If any one or more of the components next to polyamide (PA-6) is left out, the overall performance is less good. The heat stabilizer in combination with the aromatic groups in the polyamide or the nigrosine boosts the performance of the pinch line.

The heat stabilizer is suitably selected from primary antioxidants, secondary antioxidants, and metal halides; and any mixtures or combinations thereof. Primary antioxidants are typically radical scavengers and secondary aromatic amines. The radical scavengers can be, for example, hindered phenols such as BHT or analogues thereof. The secondary aromatic amines can be, for example, an alkylated-diphenylamine. Secondary antioxidants are typically hydroperoxides scavengers, for example phosphite esters and thioethers. Metal halides suitable as heat stabilizers are, for example, metal halides. An example thereof is CuI. CuI is suitably combined with an alkali halide, for example KI. Preferably the heat stabilizer comprises at least a metal halide stabilizer.

The heat stabilizer can be present in an amount varying over a wide range. Suitably, the heat stabilizer is present in an amount in the range of 0.05-3 wt. %, relative to the total weight of the polymer composition, although higher amounts can be used as well. Preferably the amount is in the range of 0.1-2.5 wt. %, more preferably 0.1-2 wt. %, relative to the total weight of the polymer composition. A higher amount minimum amount of stabilizer has the advantage that the strength of the pinch line is further increased.

The impact modifier (c) can be any known impact modifier suitable for polyamide-based polymer compositions. Impact modifiers as such are known and are rubber-like polymers that not only contain apolar monomers such as olefins, but also polar or reactive monomers such as, among others, acrylates and epoxide, acid or anhydride containing monomers. Examples include copolymers of ethylene with (meth)acrylic acid and ethylene/propylene copolymers functionalized with anhydride groups. Special grades of impact modifier have a core-shell structure. The advantage of impact modifiers is that they do not only improve the impact strength of the polymer composition but also contribute to an increase in viscosity.

The impact modifier can be present in an amount varying over a wide range. The impact modifier is suitable present in an amount of at least 1 wt. % with respect to the total amount of the polymer composition. Preferably the amount of impact modifiers is at least 5 wt. %, more preferably at least 7 wt. %, and even more preferably at least 10 wt. %. This has the advantage that the impact strength is good.

Preferably, the amount of impact modifier is at most 40 wt. % with respect to the total amount of the polymer composition, more preferably at most 30 wt. % and even more preferred at most 20 wt. %. Most advantageous is an amount of impact modifier between 10 and 20 wt. %. This has the advantage that the barrier properties remain sufficient in combination with good stiffness performance.

In a preferred embodiment of the polymer composition and the blow molded plastic container according to the invention, the impact modifier (c) is present in an amount of 2-40 wt. %, preferably 5-30 wt. %.

The polymer composition further suitably comprises a nucleating agent (e). A nucleating agent is suitably present for further enhancing the barrier properties of the polyamide in the plastic container. The term “nucleating agent” is known to a person skilled in the art and refers to a substance which when incorporated in a polymer, forms nuclei for the growth of crystals in the polymer melt. Suitable nucleating agents include micro-talcum, carbon black, silica, titanium dioxide, and nano-clay.

The nucleating agent is suitably present in an amount of at least 0.001 weight percent with respect to the total amount of the polymer composition. Preferably the nucleating agent is present in an amount of at least 0.01 wt. %, more preferably at least 0.05 wt. %, and most preferred at least 0.1 wt. % with respect to the total amount of the polymer composition. Preferably the nucleating agent is present in an amount of at most 5 wt. %, more preferably at most 3 wt. % and even more preferably at most 1 wt. % with respect to the total amount of the polymer composition.

Preferably, the nucleating agent is micro-talcum. This micro-talcum preferably has a median diameter of less than 1 micrometer, more preferably less than 0.7 micrometer, even more preferred less than 0.6 micrometer. This has the advantage that the micro-talcum is more effective in improving barrier properties than talcum particles with a higher median diameter.

Micro-talcum may be present in the polymer composition in very low amounts, such as in an amount of at least 0.001 wt. % with respect to the total amount of the polymer composition, preferably at least 0.01 wt. %, more preferably at least 0.02 wt. %, even more preferably at least 0.04 wt. %. Preferably, micro-talcum may be present in the polymer composition in an amount of at most 0.8 wt. % with respect to the total amount of the polymer composition, more preferably at most 0.5 wt. % and even more preferred at most 0.2 wt. %.

In a preferred embodiment of the invention, the polymer composition comprising the polyamide consisting of copolymer (A1) or blend (A2), as well as the blow molded plastic container made thereof, further comprises nigrosine, preferably in an amount of 0.01-5 wt. %, more preferably 0.1-3 wt. % relative to the total weight of the polyamide composition. The combination of presence of aromatic rings in the polyamide and presence of nigrosine in the composition results in even better retention of the integrity of the pinched seamline after subjecting to mechanical loads. More preferably, the polymer composition as well as the blow molded plastic container comprise 0.2-2.5 wt. % nigrosine, relative to the total weight of the polyamide composition.

In another preferred embodiment, the polyamide in the composition as well as in the blow molded plastic container comprises repeat units derived from monomer having an aromatic ring in an amount of 1-10 mole %, preferably 2-8 mole %, relative to the total molar amount of lactam, diamine and dicarboxylic acid. A higher minimum amount has the advantage of better pinch line performance, whereas a lower maximum amount has the advantage of impact performance will remain better.

In the first embodiment of the present invention, the polyamide (a) consists of
a copolyamide (A1) consisting of repeat units derived from lactam, diamine and dicarboxylic acid, and optionally chain stoppers or branching units or a combination thereof, or
a blend (A2) of at least two polyamides, comprising at least one polyamide comprising repeat units derived from lactam, and at least one polyamide comprising repeat units derived from diamine and dicarboxylic acid, wherein the polyamide comprises 75-97.5 mole % of repeat units derived from caprolactam and 1-12 mole % of repeat units derived from monomer having an aromatic ring, relative to the total molar amount of lactam, diamine and dicarboxylic acid.

Herein the blend (A2) suitably comprises a blend of polyamide 6 (PA-6) and a semi-aromatic polyamide consisting of repeat units derived from diamine and dicarboxylic acid, and optionally chain stoppers and or branching units. Suitably, PA-6 and the semi-aromatic polyamide are used in weight percentages of respectively 75-97.5 wt. % and 2.5-25 wt. %, wherein the weight percentages (wt. %) are relative to the combined weight of the PA-6 and the semi-aromatic polyamide.

The blend (A2) may also comprise a blend of polyamide 6 (PA-6), the said semi-aromatic polyamide comprising at least repeat units derived from diamine and dicarboxylic acid and the above mentioned copolymer consisting of repeat units derived from a lactam, diamine and dicarboxylic acid, and optionally chain stoppers or branching units, provided that the polyamide (A), as a whole consisting of the blend (A2), comprises 75-97.5 mole % of repeat units derived from lactam and 1-12 mole % of repeat units derived from monomers comprising an aromatic ring. Herein the mole % are relative to the total molar amount of lactam, diamine and dicarboxylic acid.

In a preferred embodiment of the invention, the semi-aromatic polyamide in the composition and in the blow molded plastic container made thereof, is selected from either amorphous semi-aromatic polyamides or semi-crystalline semi-aromatic polyamides having a melting temperature of at most 250° C., or a combination thereof. The polyamide in said polymer composition in the blow molded plastic container preferred embodiment, as a matter of fact resulting from the use of a PA-6, optionally combined with a semi-crystalline semi-aromatic polyamide with a melting temperature of at most 250° C., also has a melting temperature of at most 250° C. Preferably, ‘the polyamide has a melting temperature of at least 200° C. and most 240° C. Herein the melting temperature is measured on the semi-crystalline semi-aromatic polyamide with differential scanning calorimetry (DSC) by the method according to ISO-11357-1/3, 2011, on pre-dried samples in an N₂ atmosphere with heating and cooling rate of 10° C./min. Herein Tm has been calculated from the peak value of the highest melting peak in the second heating cycle.

With the composition comprising an amorphous polyamide, or a polyamide component with a melting temperature of at most 250° C., preferably at most 240° C., the polymer composition can be melt processed in the extrusion step at a lower temperature. The result thereof is that the performance of the pinch line of the blow molded plastic container becomes better. This has been demonstrated with a series of experiments, wherein the blow molded plastic container according to the invention showed the best results for the pinched seamline after subjecting to mechanical loads. Furthermore, too high a content in amorphous semi-aromatic polyamide has the disadvantage of poor barrier properties or a negative effect on cold impact, and too high a content in semi-crystalline semi-aromatic polyamide has the disadvantage of a more critical processing window and less pinch line performance.

Herein, the melting temperature (Tm) is measured by the DSC method according to ISO-11357-113, 2011, on pre-dried samples in an N₂ atmosphere with heating and cooling rate of 20° C./min. Herein Tm has been calculated from the peak value of the highest melting peak in the second heating cycle.

Suitably, the polyamide in the polymer composition as well as in the blow molded plastic container comprises an amorphous semi-aromatic polyamide. Suitably, the amorphous semi-aromatic polyamide is selected from PA-XI/XT copolymers, wherein X is a diamine, I is isophthalic acid and T is terephthalic acid. Herein I and T are preferably present in molar amounts of at least 40 mole % for I, and at most 60 mole % for T, relative to the total molar amount of I and T. The diamine can be, for example, a linear aliphatic diamine, a branched aliphatic diamine or a cycloaliphatic diamine, or may comprise a combination thereof.

Also, the polyamide in the polymer composition suitably comprises a semi-crystalline semi-aromatic polyamide with a melting temperature of at most 250° C.

Herein the semi-crystalline semi-aromatic polyamide can be any from PA-XT/XI, PAXT/X6, PAXT/XI/X6, and PA-L/XT copolyamides, and any copolymers thereof. Herein wherein X is a diamine, I is isophthalic acid and T is terephthalic acid and L is a lactam. Herein T and I are preferably present in molar amounts of more than 50% for T, and less than 50 mole % for I. L can be any lactam, but preferably is caprolactam. The diamine can be, for example, a linear aliphatic diamine, a branched aliphatic diamine or a cycloaliphatic diamine, or may comprise a combination thereof, and preferably comprises at least a linear aliphatic diamine. Also, the semi-crystalline semi-aromatic polyamide is preferably selected from PA-6/XT copolymers, for example PA6/6T.

The polymer composition of which the blow molded plastic container according to the invention is made, may comprise further components, next to the polyamide (a) and the heat stabilizer (b), and the impact modifier (c), nigrosine (d) and nucleating agent (e).

Suitably, the polymer composition comprises reinforcing fibers, or inorganic fillers, or one or more further additives, or a combination thereof. Reinforcing fibers are advantageously present if the blow molded plastic container is intended to be used as a fuel container without additional external reinforcement.

Suitably, the reinforcing fibers are selected from glass fibers and carbon fibers. Suitable glass fibers generally have a diameter of 5-20 micron, preferably 8-15 micron, and are provided with a coating suitable for use in polyamide. An advantage of a polymer composition comprising glass fibers is its increased strength and stiffness, particularly also at higher temperatures, which allows use at temperatures up to close to the melting point of the polyamide in the polymer composition. The reinforcing fibers, in particular glass fibers, are suitably present in an amount of 1-30 wt. %, preferably 5-25 wt. %, and most preferably 10-20 wt. %, relative to the total weight of the polymer composition. Carbon fibers, when used, are preferably present in amount of at most 20 wt. % with respect to the total polymer composition.

If the blow molded plastic container is intended to be used as a liner in a hydrogen gas tank, comprising an external reinforcement next to the liner, the polymer composition preferably does not comprise reinforcing fibers. The advantage thereof is . . . . The composition preferably comprises inorganic fillers, in particular inorganic fillers with a plate like structure. The advantage thereof is that plate like inorganic fillers enhance the barrier properties. Suitable fillers are mineral fillers such as clay, mica, talc, and glass spheres. The inorganic fillers are suitably present in an amount of 1-30 wt. %, preferably 2-25 wt. %, more preferably 5-20 wt. %, relative to the total weight of the polymer composition.

The polymer composition may comprise a combination of inorganic fillers or reinforcing fibers. The combined amount thereof is suitably in the range of 5-30 wt. %, preferably 10-25 wt. %, relative to the total weight of the polymer composition.

The blow molded plastic container according to the invention, and the composition used therein can optionally comprise other additives such as colorants, release agents, lubricants and UV stabilizers. UV stabilizers are advantageously present when the blow molded plastic container is intended for unsupported use, i.e. in absence of a protective shell. The composition from which the blow molded plastic container is made, suitably comprises 0.01-20 wt. %, preferably 0.01-10 wt. % of one or more further additives.

In a particular embodiment, the polymer composition comprises either
(f) reinforcing fibers in an amount of at most 20 wt. %, preferably at most 10 wt. %; or
(g) inorganic fillers in an amount of at most 20 wt. %, preferably at most 10 wt. %; or
(h) one or more further additives in a total amount of at most 20 wt. %, preferably at most 10 wt. %; or
any combination thereof, wherein the total amount of the combination is at most 30 wt. %, preferably at most 25 wt. % and more preferably at most 20 wt. %; and wherein the weight percentages are relative to the total weight of the polymer composition.

The blow molded plastic container according to the invention is made by an extrusion blow molding process. Extrusion blow-molding is here understood to comprise at least the following steps:
heating a polymer composition to obtain a polymer melt;
extruding the polymer melt thereby forming a hot parison from the polymer melt;
closing a mold around the hot parison, while
   blowing a gas into the hot parison, thereby expanding the hot parison and pressing it against a mold cavity until it cools and solidifies to form an expanded part, and
   pinching-off extreme parts from the expanded part, thereby forming a pinched plastic container;
opening the mold and ejecting the plastic container.

The extrusion blow molding process for making a blow molded plastic container according to the invention comprises an extrusion step and a molding step, comprising
extruding a polymer melt of a polymer composition thereby forming a hot parison from the polymer melt;
closing a mold around the hot parison, while
   blowing a gas into the hot parison, thereby expanding the hot parison and pressing it against a mold cavity until it cools and solidifies to form an expanded part, and
   pinching-off parts from the expanded part, thereby forming a pinched plastic container;
      wherein the polymer composition is a polymer composition as described above or any particular or special embodiment thereof.

In a particular embodiment of the extrusion blow molding process according to the present invention, wherein the sum of the extrusion time Te needed for the extrusion step and the mold closing time Tmc needed for the molding step is at least 5 seconds. More particular the sum {Te+Tmc} at least 10 seconds, even more particular at least 15 seconds. The effect of the blow molded plastic container according to the invention is that it allows for a longer processing time {Te+Tmc}.

The present invention also relates to a fuel tank, more particular a gas storage tank, comprising a liner and a protective shell around the liner. In the fuel tank according to the invention, the liner is a blow molded plastic container according to the present invention, or any special or preferred embodiment thereof as described above In a preferred embodiment, the liner in the gas storage tank is a blow molded plastic container made of a non-reinforced polymer composition. In other words, the liner does not comprise reinforcing fibers.

The protective shell around the liner suitably is a reinforcing mantle made of a structural fiber composite wrapped around the liner. Preferably, the reinforcing mantle made from unidirectional (UD) continuous fiber-reinforced thermoplastic tapes wrapped around the liner. Preferably, the tapes comprise continuous carbon fiber or continuous glass fibers.

In a special embodiment, the gas tank is a cylindrical compressed (pressurized) gas storage tank (oxygen, nitrogen, H2, CNG) comprising a liner with pinch lines at the bottom and top end.

### EXAMPLES

Materials Used

Polyamide 1 PA6 with a relative viscosity of 2.5

Polyamide 2 PA-6I/6T amorphous semi-aromatic polyamide, Tg 125° C.

Polyamide 3 PA-6/6T, semi-crystalline semi-aromatic polyamide, Tm 205° C.

Polyamide 4 PA-6/IPDT copolymer

Impact modifier maleic anhydride (MAH) grafted ethene copolymer

Nucleating agent Micro-talcum; Median diameter of 0.50 micrometer

Heat stabilizer A CuI/KI

Heat stabilizer B Irganox 1098

Compositions

For the preparation of the compositions use was made of a twin-screw extruder, wherein the components were first dry-blended and then melt-mixed in the extruder while applying standard conditions for polyamide 6 compounds.

Preparation of Blow Molded Containers

Blow molded containers were prepared on a lab scale blow molding machine. Herein the polymer compositions were melt extruded through a circular orifice, thereby forming a parison from the molten polymer, and the parison was expanded by pressurized gas and pressed against a mold cavity while the mold closed and pinched of the end parts. Meanwhile the expanded parison cooled and solidified to form a molded and pinched container. Then the mold was opened, and the molded and pinched container was ejected from the mold. In a first series of experiments, the extrusion time Te was 27 seconds and the mold closing time Tmc was 7 seconds, resulting in a combined processing time Te+Tmc of 34 seconds. In a second series of experiments, the extrusion time Te was 14 seconds and the mold closing time Tmc was 1 second, resulting in a combined processing time Te+Tmc of 15 seconds.

Testing method for mechanical strength of the pinch line.

The pinch line strength was tested in following manner: first a section of pinch line was cut from the blow molded container. Then this section was bended by hand or in a vice inside-out and checked whether it broke. When it was easy to break, the result reported was ‘break’. When it was difficult to break, the result reported was ‘no break’.

The compositions and test results for the various Examples I-VIII according to the invention and Comparative Experiments A-F are listed in Tables 1 and 2. Herein IM is impact modifier; Mole % AM: is mole % of a monomer containing an aromatic group; and Mass % Stab is the weight percentage of heat stabilizer.

TABLE 1
First series of compositions and test results at ‘Condition 1’
for Comparative Experiments A-C and Examples I-IV.

| Com- | | | | | | | |
|---|---|---|---|---|---|---|---|
| ponents | CE-A | CE-B | CE-C | EX-I | EX-II | EX-III | EX-IV |
| PA #1 | 77 | 71.9 | 76.4 | 71.4 | 66.73 | 71.45 | 66.67 |
| PA #2 | | 5 | | 5 | 10 | 5 | 10 |
| IM | 23 | 23 | 23 | 23 | 23 | 23 | 23 |
| Stab-A | | | 0.17 | 0.17 | 0.17 | 0.17 | 0.17 |
| Stab-B | | | 0.33 | 0.33 | | 0.33 | 0.16 |
| MB | | 0.1 | 0.1 | 0.1 | 0.1 | 0.05 | |
| Total | 100 | 100 | 100 | 100 | 100 | 100 | 100 |
| Mole % | 0 | 3.12 | 0 | 3.14 | 6.32 | 3.08 | 6.07 |
| AM | | | | | | | |
| Mass % | 0 | 0 | 0.5 | 0.5 | 0.17 | 0.5 | 0.33 |
| Stab | | | | | | | |
| Results | break | break | break | no | no | no | no |
| at | | | | break | break | break | break |
| Condition | | | | | | | |
| 1 | | | | | | | |

Condition 1: total processing time Te + Tmc 34 seconds

TABLE 2
Second series of compositions and test results at ‘Condition 2’
for Comparative Experiments D-F and Examples V-VIII.

| | CE- | CE- | CE- | EX- | EX- | EX- | EX- |
|---|---|---|---|---|---|---|---|
| | D | E | F | V | VI | VII | VIII |
| PA #1 | 77 | 69 | 76.41 | 71.41 | 66.74 | | 46.67 |
| PA #2 | | 5 | | 5 | 10 | | |
| PA #3 | | | | | | 76.51 | |
| PA #4 | | | | | | | 30 |
| IM | 23 | 23 | 23 | 23 | 23 | 23 | 23 |
| Stab-A | | | 0.16 | 0.16 | 0.16 | 0.16 | 0.16 |
| Stab-B | | | 0.33 | 0.33 | | 0.33 | 0.17 |
| Micro- | | 0.1 | 0.1 | 0.1 | 0.1 | | |
| talcum | | | | | | | |
| | 100 | 100 | 100 | 100 | 100 | 100 | 100 |
| Mole % | 0 | 3.12 | 0 | 3.16 | 6.35 | 4.63 | 7.15 |
| AM | | | | | | | |
| Mass % | 0 | 0 | 0.49 | 0.49 | 0.16 | 0.49 | 0.33 |
| Stab | | | | | | | |
| Result at | break | break | break | no | no | no | no |
| Condition | | | | break | break | break | break |
| 2 | | | | | | | |

Condition 2: total processing time Te + Tmc 15 seconds

1. A blow molded plastic container for a fuel tank liner comprising a pinched seam line, wherein the tank is made of a polymer composition comprising:
a. polyamide (A) consisting of
a copolyamide (A1) consisting of repeat units derived from lactam, diamine and dicarboxylic acid, and optionally chain stoppers or branching units or a combination thereof, or
a blend (A2) of at least two polyamides, comprising at least one polyamide comprising repeat units derived from lactam, and at least one polyamide comprising repeat units derived from diamine and dicarboxylic acid,
wherein the polyamide (A) comprises 75-97.5 mole % of repeat units derived from caprolactam and 1-12 mole % of repeat units derived from monomer having an aromatic ring, relative to the total molar amount of lactam, diamine and dicarboxylic acid;
b. a heat stabilizer; and
c. an impact modifier.

2. The blow molded plastic container according to claim 1, wherein the heat stabilizer is selected from primary antioxidants, secondary antioxidants and metal halides; and mixtures or combinations thereof; and preferably comprises a metal halide stabilizer.

3. The blow molded plastic container according to claim 1, wherein the heat stabilizer (b) is present in an amount of 0.05-3 wt. %, preferably 0.1-2.5 wt. %, more preferably 0.1-2 wt. %, relative to the total weight of the polymer composition.

4. The blow molded plastic container according to claim 1, wherein the impact modifier (c) is present in an amount of 1-40 wt. %, preferably 5-30 wt. %, relative to the total weight of the polymer composition.

5. The blow molded plastic container according to claim 1, wherein the polymer composition comprises 0.01-5 wt. %, preferably 0.1-3 wt. % nigrosine (d), relative to the total weight of the polyamide composition.

6. The blow molded plastic container according to claim 1, comprising (e) a nucleating agent; preferably comprising micro-talcum.

7. The blow molded plastic container according to claim 4, wherein the nucleating agent (e) is present in an amount of 0.001-3 wt. %, preferably 0.01-1 wt. %, wherein the weight percentages are relative to the total weight of the polymer composition.

8. The blow molded plastic container according to claim 1, wherein the polyamide comprises repeat units derived from monomer having an aromatic ring in an amount of 1-10 mole %, preferably 2-8 mole %, relative to the total molar amount of lactam, diamine and dicarboxylic acid in the polyamide.

9. The blow molded plastic container according to claim 1, wherein the polyamide comprises a semi-aromatic polyamide selected from either amorphous semi-aromatic polyamides or semi-crystalline semi-aromatic polyamides having a melting temperature of at most 250° C., or a combination thereof.

10. The blow molded plastic container according to claim 1, wherein the polyamide in the polymer composition has a melting temperature of at most 250° C., preferably a melting temperature of at least 200° C. and most 240° C.

11. The blow molded plastic container according to claim 1, wherein the polymer composition comprises either
(f) reinforcing fibers in an amount of at most 20 wt. %, preferably at most 10 wt. %; or
(g) inorganic fillers in an amount of at most 20 wt. %, preferably at most 10 wt. %; or
(h) one or more further additives in a total amount of at most 20 wt. %, preferably at most 10 wt. %; or
any combination thereof, wherein the total amount of the combination is at most 30 wt. %, preferably at most 25 wt. % and more preferably at most 20 wt. %, and wherein the weight percentages are relative to the total weight of the polymer composition.

12. An extrusion blow molding process for making a blow molded plastic container comprising an extrusion step and a molding step, comprising
extruding a polymer melt of a polymer composition thereby forming a hot parison from the polymer melt;
closing a mold around the hot parison, while
blowing a gas into the hot parison, thereby expanding the hot parison and pressing it against a mold cavity until it cools and solidifies to form an expanded part, and
pinching-off parts from the expanded part, thereby forming a pinched plastic container;
wherein the polymer composition is a polymer composition as described in claim 1.

13. The blow molding process according to claim 12, wherein the sum of the extrusion time Te needed for the extrusion step and the mold closing time Tmc needed for the molding step is at least 5 seconds.

14. Fuel tank comprising a liner and a reinforcing mantle around the liner, wherein the liner is a blow molded plastic container according to claim 1.
